(19) United States
(12) Patent Application Publication
(10) Pub. No.: US 2017/0076412 A1
(43) Pub. Date: Mar. 16, 2017

(54) SYSTEM FOR DETERMINATION AND TRANSFER OF ASSETS

(71) Applicant: BANK OF AMERICA CORPORATION, Charlotte, NC (US)

(72) Inventors: Katherine Dintenfass, Charlotte, NC (US); Matthew Hsieh, Charlotte, NC (US); Scott R. Enscoe, Charlotte, NC (US); Alicia C. Jones-McFadden, Fort Mill, SC (US); Kevin Andrew O'Neil, JR., Hamilton, NJ (US); Minh N. Vuong, Clovis, CA (US); William F. Borowski, Millbury, MA (US)

(21) Appl. No.: 14/853,716

(22) Filed: Sep. 14, 2015

(51) Int. Cl. G06Q 50/18; G06Q 10/10

(52) U.S. Cl. CPC G06Q 50/186; G06Q 10/10

(57) ABSTRACT

Embodiments of the invention are directed to systems, methods, and computer program products for distributing assets upon the occurrence of a triggering event. Embodiments of the invention may be configured to identify a main account of a benefactor containing assets that the benefactor desires to distribute upon the occurrence of a triggering event; receive, information that identifies one or more individuals; create a subaccount that is associated with the main account that names the benefactor and at least one of the one or individuals as managers of the account; receive designations for transferring a portion of the assets from the main account into the subaccount based on the occurrence of the triggering event; identify the occurrence of the triggering event; and transfer the portion of the assets from the main account into the subaccount based on identifying the occurrence of the triggering event.

### BACKGROUND

Efficient disposition of assets at a triggering event is important to ensure efficient disposal of assets and efficient access and use of those assets by the recipient. While many systems are benefactor driven and allow the benefactor to view each asset, monitor it, and designate beneficiaries, systems have not been developed that provide a beneficiary with information regarding assets to which they are designated. Thus, systems are needed for efficient managements and disposition of assets.

### BRIEF SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Embodiments of the invention are directed to systems, methods, and computer program products for distributing assets upon the occurrence of a triggering event. In some embodiments, the invention may be configured to identify a main account of a benefactor. The main account may contain assets of the benefactor that the benefactor desires to distribute to one or more individuals upon the occurrence of a triggering event.

Further, the invention may be configured to receive, from the benefactor, information that identifies each of the one or more individuals. Using the information, the invention may be configured to create a subaccount for each of the one or more individuals that are associated with the main account. The subaccount names the benefactor and at least one of the individuals as managers on the account. Prior to the occurrence of the triggering event, the subaccount does not include any portion of the assets of the main account.

In some embodiments of the invention, the invention may be configured to receive, from the benefactor, designations for transferring a portion of the assets from the main account into the subaccount based on the occurrence of the triggering event.

In yet other embodiments, the invention may be configured to identify the occurrence of the triggering event. Based on determining the occurrence of the triggering event, the system may be configured to transfer a portion of the assets from the main account into the subaccount.

In some embodiments, the invention may be configured to receive one or more restrictions for conducting transactions using the subaccount. The one or more restrictions limit completion of a transaction based on either an amount of the transaction, or a recipient of the transaction. The invention may further be configured to receive a notification that the individual named on the subaccount is attempting to perform the transaction using the subaccount. The notification comprises at least the amount of the transaction and the recipient of the transaction. The invention may be configured to determine whether the one or more restrictions apply to the transaction based on either the amount of the transaction or the recipient of the transaction. Further, the invention may be configured to complete the transaction if the one or more restrictions do not apply to the transaction.

In a specific embodiment of the invention, the triggering event may be the death of the benefactor. Accordingly, the invention may be configured to create a subaccount for receiving assets from the main account to pay for funeral related expenses of the benefactor.

In other embodiments of the invention, the invention may be configured to communicate a notification of the occurrence of the triggering event to at least one of the individuals named to manage the subaccount. Communicating the notification may not occur until after the occurrence of the triggering event.

Further, in other embodiments of the invention, the invention may be configured to identify a purpose for the subaccount. And where the subaccount does have a purpose, the invention may determine that the purpose of the subaccount is no longer valid after the occurrence of the triggering event.

While yet in other embodiments, the invention may be configured to identify residual funds included in the subaccount. The residual funds may include any assets left in the subaccount after the purpose of the subaccount is determined to be no longer valid. After identifying the residual funds, the invention may apply a second set of limitations for restricting transactions on the subaccount based on identifying the purpose is no longer valid. The second set of limitations is less restrictive than the each of the one or more limitations. Thus, transactions may be performed using the residual funds included in the subaccount that could not be performed prior to determining that the purpose of the subaccount was no longer valid.

In some embodiments of the invention, determining that the purpose of the subaccount is no longer valid is based on the occurrence of a second triggering event. The second triggering event occurs after the occurrence of the triggering event. And the second triggering event causes the purpose of the subaccount to no longer be valid.

While in other embodiments of the invention, the second triggering event may be a life event of an individual other than the benefactor.

### BRIEF DESCRIPTION OF THE DRAWINGS

Having thus described embodiments of the invention in general terms, reference will now be made to the accompanying drawings, where:

FIG. 1 is a diagram illustrating a beneficiary designation environment, in accordance with embodiments of the present invention;

FIG. 2 is a flow chart illustrating a general process flow for distributing assets upon the occurrence of a triggering event, in accordance with various embodiments of the invention;

FIG. 3 is a flow chart illustrating a general process flow for performing transactions using a subaccount designated by a benefactor, in accordance with various embodiments of the present invention;

FIG. 4 is an illustration of an interface for viewing and updating a benefactor profile, in accordance with various embodiments of the present invention; and

FIG. 5 is an illustration of an interface for viewing beneficiary information, in accordance with various embodiments of the present invention.

### DETAILED DESCRIPTION OF EMBODIMENTS OF THE INVENTION

Embodiments of the present invention may now be described more fully hereinafter with reference to the accompanying drawings, in which some, but not all, embodiments of the invention are shown. Indeed, the invention may be embodied in many different forms and should not be construed as limited to the embodiments set forth herein. Rather, these embodiments are provided so that this disclosure may satisfy applicable legal requirements. Like numbers refer to like elements throughout.

Embodiments of the invention are directed to systems, methods, and computer program products for distributing assets upon the occurrence of a triggering event. Particularly, a benefactor may set up a financial account that contains assets managed by the benefactor. The benefactor may have a financial account that includes assets that the benefactor would like to distribute upon the occurrence of a triggering event of the benefactor. The triggering event may be a life event such as a marriage, a divorce, a sale of a home, a birth of a baby, and the like. Alternatively, the triggering event may also be associated with an estate planning decision of the benefactor, which may include incompetency or death of the benefactor. As funds are typically frozen after these types of triggering events without a legal imposition, the benefactor may wish to direct how funds should be distributed upon the occurrence of such an event without the need of the legal imposition. For this purpose, a financial institution that manages the account of the benefactor may offer a system to aid the benefactor in directing how assets within the account should be distributed upon the occurrence of such a triggering event. This system may enable the benefactor to designate one or more individuals that the benefactor desires to receive money upon the occurrence of the triggering event. These individuals may include beneficiaries that will receive an inheritance from the assets, and may also include other individuals that would be designated to handle the affairs of the benefactor upon the triggering event (e.g. executor, caretaker). For each of these individuals, the system may create a subaccount from a main account that contains the assets of the benefactor. Each of the subaccounts is set up in the name of the benefactor and at least one of the individuals, such that any person named on the account may manage assets within the account. For example, a subaccount may be set up that specifies the benefactor and an executor of the estate of the benefactor as managers of the subaccount. These subaccounts, after being set up and prior to the occurrence of the triggering event, do not contain any assets from the main account. The benefactor may designate an amount of assets from the main account to pass to the each of the subaccounts upon the occurrence of the triggering event. For example, the benefactor may designate $500 to be transferred from the main account to a first subaccount upon the death of the benefactor. After transfer, because the accounts may be managed by any individual named on the account, transactions may be performed by any individual named as a manager on the account. In some embodiments, the benefactor may be able to designate prepayment of expenses prior to the triggering event that would then be transferred upon the occurrence of the triggering event. For example, the benefactor may designate $10,000 to be transferred to pay for funeral services upon the triggering event. This may be performed as an emergency cash withdrawal that would allow the executor or another individual handle the arrangements. In other embodiments, the withdrawal may be used for other purposes, such as pet care.

The benefactor may further be able to designate how the assets may be managed after the occurrence of the triggering event. The benefactor may designate that assets within a certain subaccount may only be paid to certain individuals or groups of individuals. For example, the benefactor may set a limitation on the subaccount that assets within the account may be paid to a funeral service provider. In addition to specifying individuals or groups of individuals that may receive assets of the subaccount, the benefactor may further specify a spending limit of the assets for a particular purpose. For example, the benefactor may specify that $5000 may be spent on funeral arrangements. Using these restrictions, the system may identify a transaction that is being performed using the subaccount that contains a limitation. From the transaction, the system identifies at least a payee and an amount of the transaction. The system determines whether the limitation applies to either the payee or the amount of the transaction. If the limitation does apply, the system may cancel the transaction. Alternatively, if the limitation does not apply, the system may approve the transaction. Thus, although an individual may be named as a manager of the assets within an account, the system may prevent such an individual from actually making distributions outside restrictions established by the benefactor.

As an example of how this may work, the benefactor may designate an executor to receive money from a main account of the benefactor. The system sets up a subaccount and names the executor and the benefactor on the account. The benefactor designates $10,000 to be transferred from the main account to the subaccount upon the death of the benefactor. The benefactor further designates that the funds in the subaccount may be used for funeral arrangements and no more than $500 may be used for floral arrangements. At some point after the subaccount has been created and the benefactor has made appropriate designations, the system may determine that the triggering event has occurred, and as a result transfers the designated $10,000 accordingly. The executor named on the account may use the proceeds to pay for the funeral arrangements of the benefactor. Accordingly, the system may recognize that the executor is attempting to complete a transaction with a florist for an amount of $800. The system may recognize that the $800 transaction does not comply with the limitation set by the executor and as a result, the system may decline the transaction.

The system may further be configured to determine how to handle residual funds of the account. The residual funds may be a result of funds remaining in the account after the purpose of the account has been fulfilled. For example, all funeral arrangement costs were less than the amount transferred into the subaccount. Additionally, the residual funds may be a result of an occurrence of a second triggering event that may or may not be associated with the benefactor. In a first example, the first triggering event may be the incompetency of the benefactor. The benefactor may have designated an amount be transferred to a subaccount to provide medical support for the benefactor during this period of incompetency. The second triggering event may be the death of the benefactor. Upon death, medical care of the benefactor would no longer be required. As a second example, the triggering event may be an event associated with an individual named on the account. The benefactor may have designated a portion of assets be transferred to the subaccount to pay for educational expenses of the individual. The benefactor may designate that upon graduation of the individual, all of the funds within the account become residual. The benefactor may designate the disposition of residual funds within the accounts. Thus, upon the occurrence of a second triggering event, the funds are disposed of according to the designation set by the benefactor. For example, the benefactor may allow the individual named on the account to transfer money according to a second set of restrictions. The benefactor may further allow the residual to be transferred into the estate of the benefactor. In lieu of determining an occurrence of a second triggering event, the benefactor may state a time limit for the use of funds before becoming residual.

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loans associations, credit unions, investment companies, insurance companies and the like. In some embodiments, the entity may allow a user to establish an account with the entity.

As used herein, an “account” or “financial account” may be the relationship that the user has with the entity. Examples of accounts include a deposit account, such as a transaction account (e.g. banking account), a savings account, an investment account, a money market account, a time deposit, a demand deposit, a pre-paid account, a credit account, a rewards account, an electronic wallet, a non-monetary user profile that includes only personal information with the user, or the like. The account is associated with and/or maintained by the entity. In other embodiments, an entity may not be a financial institution. In still other embodiments, the entity may be a merchant.

In some embodiments, a “user” may be a customer (e.g. an account holder or a person who has an account at the entity) or a potential customer (e.g. person who has submitted an application for an account, a person who is the target of marketing materials that are distributed by the entity, a person who applies for a loan that has not yet been funded). Additionally, the user may be a “benefactor” that manages multiple financial accounts that each includes assets. The benefactor may refer to an individual or an entity, where the entity may be at least one of: a business organization, a charitable organization, a non-profit organization, and the like.

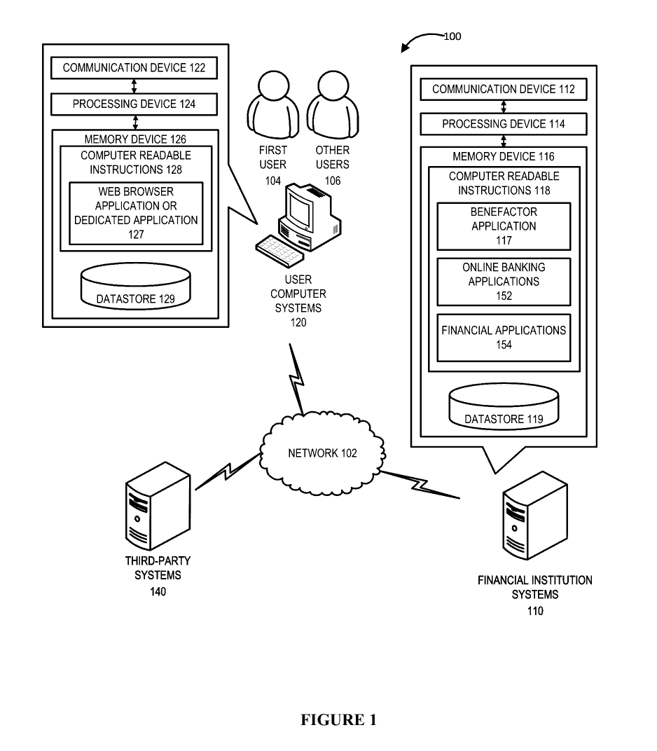

FIG. 1 illustrates a beneficiary designation environment 100, in accordance with embodiments of the present invention. As illustrated in FIG. 1, one or more financial institution systems 110 are operatively coupled, via a network 102, to one or more user computer systems 120 (e.g., first user computer systems, second user computer systems, or other user computer systems), and/or one or more third-party systems 140. In this way, the first user 104 (e.g., benefactor, or the like) and the other users 106 (e.g., the second user 106, beneficiary, or the like which may or may not be customers of the financial institution) may utilize the one or more user computer systems 120 to access the financial institution applications, such as the benefactor applications 117, the online banking application 152, the financial applications 154, or other like applications of the financial institution for a user to create a benefactor profile to create subaccounts for receiving assets from a main account of the user upon a triggering event.

In some embodiments of the invention the one or more financial institution systems 110 may store user profile information, account information, financial information, transaction history, or the like about the users 104, 106, that are customers of the financial institution or associated with customers of the financial institutions. This information may include financial information of the benefactor, information for individuals that will manage one or more subaccount, information of a beneficiary, estate planning information and the like.

The network 102 may be a global area network (GAN), such as the Internet, a wide area network (WAN), a local area network (LAN), or any other type of network or combination of networks. The network 102 may provide for wireline, wireless, or a combination of wireline and wireless communication between systems, services, and/or devices on the network 102.

As illustrated in FIG. 1, the financial institution systems 110 generally comprise one or more communication devices 112, one or more processing devices 114, and one or more memory devices 116. The one or more processing devices 114 are operatively coupled to the one or more communication devices 112 and the one or more memory devices 116. As used herein, the term “processing device” generally includes circuitry used for implementing the communication and/or logic functions of a particular system. For example, a processing device 114 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The one or more processing devices 114 may include functionality to operate one or more software programs based on computer-readable instructions 118 thereof, which may be stored in the one or more memory devices 116.

The one or more processing devices 114 use the one or more communication devices 112 to communicate with the network 102 and other devices on the network 102, such as, but not limited to, the user computer systems 120, third-party systems 140, or other like systems. As such, the one or more communication devices 112 generally comprises a wireless transceiver, modem, server, electrical connection, or other device for communicating with other devices on the network 102. The one or more communication devices 112 may further include an interface that accepts one or more network interface cards, ports for connection of network devices, Universal Serial Bus (USB) connectors and the like.

As further illustrated in FIG. 1, the financial institution systems 110 comprise computer-readable instructions 118 stored in the memory device 116, which in one embodiment includes the computer-readable instructions 118 of a benefactor application 117, online banking applications 152, financial applications 154, or other applications. In some embodiments, the one or more memory devices 116 include one or more datastores 119 for storing data related to the financial institution systems 110, including, but not limited to, data created and/or used by the benefactor application 117, online banking applications 152, financial applications 154, or other applications.

The benefactor application 117 may be a tool, website, mobile device app, other computer system app, or the like that is used to allow the user to view, receive, or input information for creating and updating a benefactor profile for a benefactor. For example, as discussed in further detail later the benefactor application 117 may allow the first users 104 to create and update a benefactor profile for creating subaccounts that will receive assets of a main account of the benefactor upon the occurrence of a triggering event. The first users 104 may update the benefactor profile with information of one or more individuals that will be named as managers of the subaccounts, and an amount and type of assets to transfer into the subaccounts upon the occurrence of the triggering event.

As illustrated in FIG. 1, users 104, 106 may access the benefactor application 117 and the financial applications 154 or other financial institution applications, through a user computer system 120. The user computer system 120 may be a desktop, laptop, tablet, mobile device (e.g., smartphone device, or other mobile device), or any other type of computer that generally comprise one or more communication devices 122, one or more processing devices 124, and one or more memory devices 126.

The one or more processing devices 124 are operatively coupled to the one or more communication devices 122, and the one or more memory devices 126. The one or more processing devices 124 use the one or more communication devices 122 to communicate with the network 102 and other devices on the network 102, such as, but not limited to, the financial institution systems 110, the third-party systems 140, and/or other systems not specifically illustrated. As such, the one or more communication devices 122 generally comprise a wireless transceiver, modem, server, electrical connection, or other device for communicating with other devices on the network 102. The one or more communication devices 112 may further include an interface that accepts one or more network interface cards, ports for connection of network devices, Universal Serial Bus (USB) connectors and the like. Moreover, the one or more communication devices 112 may include a keypad, keyboard, touch-screen, touchpad, microphone, mouse, joystick, other pointer device, button, soft key, and/or other input device(s) for communicating with the users 104, 106.

As illustrated in FIG. 1, the user computer systems 120 may have computer-readable instructions 128 stored in the one or more memory devices 126, which in one embodiment includes the computer-readable instructions 128 of a web browser application or another dedicated application 127 that allows the users 104, 106 to access the benefactor application 17, the financial applications 154 or other financial institution applications, or receive or update a benefactor profile within the benefactor application 117, or other financial institution applications, or access or received information from other applications, or third-party systems 140 (e.g., applications from other financial institutions, or the like). In some embodiments, the one or more memory devices 126 include one or more datastores 129 for storing data related to the client computer systems 120, including but not limited to data created and/or used by the web browser/application 127. The web browser/application 127 may be utilized by the user 104 to access the benefactor application 117, or other financial institution applications, or receive information from and make updates to the benefactor application 117, or other financial institution applications, to view and/or access a financial planning information (e.g., suggestions to take with respect to financial accounts or other assets or liabilities, or the like). The web browser may be an application that allows the users 104, 106 to access websites over a distributed network of systems (e.g., servers), such as the Internet or an intranet. The application may be a dedicated application for a computer or mobile device that allows the users 104, 106 to access information over the distributed network of systems (e.g., servers), such as the Internet or an intranet.

The third-party systems 140 (e.g., other financial institution systems, merchant systems, other entity systems) are operatively coupled to the financial institution systems 110, and user computer systems 120, through the network 102. The third-party systems 140 have devices the same as or similar to the devices described for the financial institution systems 110 and the user computer systems 120 (e.g., one or more communication devices, one or more processing devices, one or more memory devices with computer-readable instructions, one or more datastores, or the like). Thus, the third-party systems 140 communicate with the financial institution systems 110, the user computer systems 120, and/or each other in the same or similar way as previously described with respect to the financial institution systems 110, and the user computer systems 120. The third-party systems 140, in some embodiments, provide additional information about the users 104, 106 such as but not limited to user profile information, the user's assets and liabilities, the user's investments, the user's transactions, or the like that stored by other financial institutions, merchants, or entities, which may be used by the benefactor application 117, or the like.

In some embodiments of the invention one or more of the systems may be combined with each other, or otherwise perform the functions of the other systems described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems described herein. For example, a portion of the benefactor 117 may be stored on the user computer systems 120, or may be included as a portion of the online banking applications 152, in order to achieve the invention described herein.

It should be understood, that the systems described in FIG. 1 may be configured to establish a communication link with each other in order to accomplish the steps of the processes described herein. The link may be an internal link within the same entity (e.g., within the same financial institution) or a link with the other entity systems described herein (e.g., social networking systems, third-party systems, or the like). In some embodiments, the systems may be configured for selectively monitoring accounts of multiple users on different systems. These feeds of account data can be provided via wireless network path portions through the Internet. When the system is not monitoring a source, the data need not be transmitted from the source to the Internet, although it could be. The sources of data may be made continuously available, however, continuously available does not necessarily mean that the sources actually continuously generate data, but that a source is continuously available to generate and send data real-time (i.e., within a few seconds, or the like) of receiving a request for it. In any case, the sources are continuously available to generate data, in some cases in digitized data in Internet Protocol (IP) packet format. In response to continuously monitoring the real-time data feeds from the various systems, the system may be configured to update the account information associated with the finances of multiple users, as described herein.

Moreover, it should be understood that the process flows described herein include transforming the retrieved data from the different systems (e.g., internally or externally) from the data format of the various systems to a data format associated with the benefactor application 117 for display. There are many ways in which data is converted within the computer environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

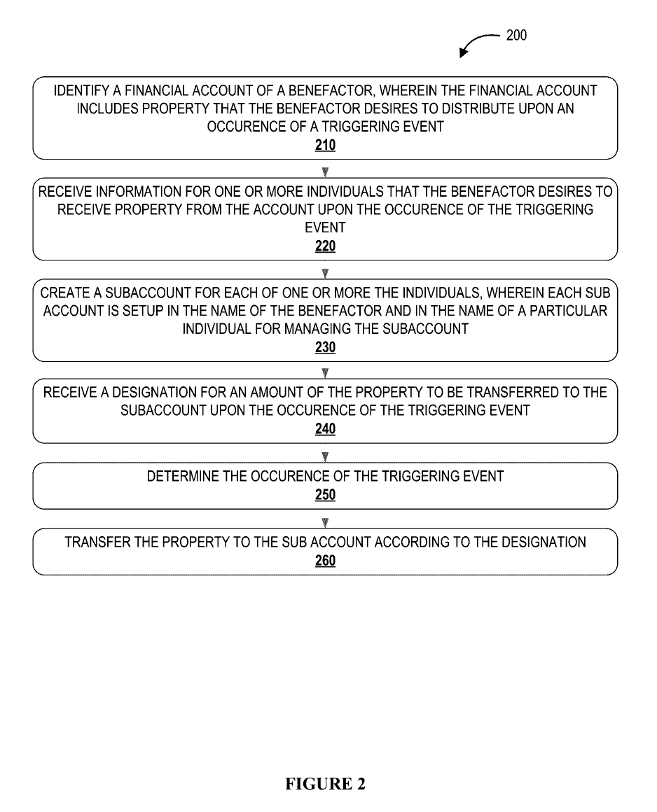

FIG. 2 illustrates a high level process flow 200 for distributing assets upon the occurrence of a triggering event, in accordance with several embodiments of the present invention. Block 210 of FIG. 2 illustrates identifying a financial account of a benefactor containing assets that the benefactor desires to distribute upon an occurrence of a triggering event. The financial account may be any account to which the benefactor has asset rights. The financial account may be personal or business account of the benefactor. Specifically, the financial account may be one of a checking account, a savings account, a money market accounts, a retirement account (e.g. IRA, 401K), an insurance policy, an investment accounts, a certificate of deposit, and the like. The assets included in the financial account are typically fungible in nature but may also include investment vehicles such as stocks or bonds. The financial account may be an active account where the benefactor uses the account to conduct transactions and deposit funds. Therefore, the type and amount of assets of the account may be updated based on transactions performed on the account.

Typically, as discussed herein, the benefactor may be an individual that desires to distribute assets from the financial to beneficiaries and/or other individuals. However, in some embodiments, the benefactor may further be an entity other than an individual. This may include, for example, a corporation, a charity, a partnership, non-profit organization, and the like. When the benefactor is an entity, the entity may designate officers that are allowed to conduct financial transactions using the financial account.

The triggering event is dependent on whether the benefactor is an individual or an entity. Where the benefactor is an individual, the triggering event may include life events such as a marriage, a divorce, purchasing a home, a birth of a child, school events, retirement, and the like. The triggering event may further include events that may influence the estate of the benefactor. These events may include the death of the benefactor or the benefactor becoming incompetent. Where the benefactor is an entity, the events may include the organization of the entity, a transfer of ownership, a dissolution, and the like. In some embodiments, the triggering event may be based on another individual. For example, the triggering event may occur when a child of the benefactor graduates from college. The triggering event may be either a one-time event or an event that occurs on multiple occasions. An example of a multiple occasion event may occur when a benefactor has multiple children and the triggering event occurs when each of the children graduate from college. In a more specific embodiment of the invention, the triggering event may prevent the benefactor from managing the account and the assets of the account are frozen as a result. This may occur due to the death or incompetency of the benefactor.

Block 220 illustrates receiving information for one or more individuals that the benefactor desires to receive assets from the financial account upon the occurrence of the triggering event. In some embodiments, the system may allow the user set up a benefactor profile that includes information for each of the individuals to whom the benefactor would like to transfer assets from the financial account. This information may include personal information that may be used to identify the individual. The information may further include financial information. This may include information that describes whether the individual is a customer of a particular financial institution. The system may further allow the benefactor to update the benefactor profile from time to time. This may include allowing the benefactor to add new individuals to or remove individuals from the benefactor profile.

After receiving the information for the one or more individuals, a subaccount for each of the one or more individuals may be created in the name of the benefactor and in the name of a particular individual for managing the subaccount, as illustrated in block 230. Typically, when the subaccount is opened and up until the occurrence of the triggering, the subaccount will not contain any assets of the financial account. Thus, the subaccount is set up in anticipation of the triggering event. In some embodiments, the subaccount may receive additional assets or funds besides the assets of the financial account and transactions may be performed using these additional funds. In some embodiments, the subaccount may be associated with the financial account such that the subaccount is part of the financial account. In this embodiment, the subaccount may not be an actual account but may be created by designation. As a subaccount will be created for each individual included in the benefactor profile, there is typically no limit to the number of subaccounts that could be created. In other embodiments of the invention, the subaccount may be a shell account.

Block 240 illustrates receiving a designation or an amount of the assets of the financial account to be transferred to the subaccount upon the occurrence of the triggering event. The benefactor may be allowed to update the benefactor profile to include a portion of the assets to transfer to the subaccount upon the occurrence of the triggering event. The benefactor may specify the amount and type of assets to transfer. For example, where the financial account is an investment account, the benefactor may designate an amount of stock to transfer to the subaccount.

Block 250 illustrates determining the occurrence of the triggering event. In some embodiments, where the benefactor is capable, the benefactor may be allowed to provide notification of the occurrence. Where the benefactor is unable to make this notification, the benefactor may, before the occurrence of the triggering event, designate an individual that could. In other embodiments, a computing device configured to monitor the triggering event may be used. For example, a computing device configured to analyze news feeds may identify the triggering event. More particularly, the triggering event could be the death of the benefactor and the computing device may analyze obituaries to determine such occurrence. Further, a computing device configured to analyze government records could analyze death certificates to determine such occurrence. Where the benefactor is a business, a computing device configured to analyze government records may analyze articles of dissolution and the like. In some embodiments, the triggering event may be calculable and may include a specified date in the future, a calculable date, a market event, and the like. In other embodiments, the triggering event may further be based on financial account details. For example, the triggering occurs when an account balance reaches a predetermined limit.

Upon the occurrence, the assets of the financial account may be transferring to the subaccount, as illustrated in block 260. Further, a notification of the triggering event may be sent to each of the individuals named on the subaccount. Also, where the beneficiary is not named on the account, notifications of the triggering event may be sent to the beneficiary. Notifications may also be communicated when the benefactor updates the benefactor profile.

In yet other embodiments, the benefactor may identify a purpose for the subaccount. The purpose may regulate account transactions. For example, a purpose may include paying for funeral expenses of the benefactor. In another example, a purpose may include paying a beneficiary's tuition while the attending college.

After the purpose has been identified, the purpose of the subaccount is monitored for validity. For example, where the purpose includes paying a beneficiary's tuition, the purpose is no longer valid when the beneficiary graduates. When a subaccount does not have a valid purpose, residual funds left in the account may be left unusable. To prevent this, the benefactor may identify a less restrictive second set of restrictions for handling transactions. Therefore, the residual funds may be used under the second set of restriction. In some embodiments, the invalid purpose of the subaccount is caused by a second triggering event which occurs after the initial triggering event. For example, the benefactor may define a first triggering event as incompetency of the benefactor and a second triggering event as the death of the benefactor. A subaccount is set up naming a health care provider as a manger. The benefactor designates funds for the purpose of paying for the benefactor's health care needs. After the first trigger event's occurrence, an occurrence of the second trigger event would remove the need to pay for the benefactor's health care needs. As the remaining funds become residual and a second set of restrictions are applied to the subaccount that are less restrictive and the health care provider may transfer the funds accordingly. In some embodiments, the residual funds may be returned to the main account or the estate of the benefactor.

In some embodiments of the invention, where the subaccount is set up for transferring assets to a beneficiary, the beneficiary may be given a password or other token for receiving information about a designation made by the benefactor to transfer the money to the beneficiary. In some embodiments, the password may be a one-time use password. Alternatively, the password may be used a predetermined or limited number of times (e.g. three times). A graphical user interface may be generated that may be accessed using the password. The graphical user interface may display details of the designation. In some embodiments, the benefactor may specify which details the beneficiary may receive. In some embodiments, after the occurrence of the triggering event, control of the account may be transferred to the beneficiary such that the beneficiary may access and manage the account. Further, in some embodiments, after the benefactor has made the designation and a subaccount generated on behalf of the beneficiary, the beneficiary may receive a notification that the subaccount has been setup. A second notification may be communicated to the beneficiary upon the occurrence of the triggering event.

In yet other embodiments, the benefactor may be enabled to update the benefactor profile to include functions that are performed after the occurrence of the triggering events. The functions may include financial transactions that the benefactor would like to perform after the triggering event. For example, a function may include setting up an account, transferring money into the account, and establishing a manager over the account. In other embodiments, the function may be to communicate documents to an insurance company that manages a policy of the benefactor. Additionally, the function could be to list a particular asset for sale. In some embodiments, after the occurrence of the triggering event, the system may automatically perform each of the functions defined by the benefactor. In other embodiments, the benefactor may designate an individual to oversee the completion of the function (e.g. executor). The system may generate a graphical user interface that displays information regarding the function and presents an option for the individual to complete the transaction. The system may be enabled to receive a response that the individual would like to complete the function. The system may then be configured to complete the function. Following the above example, after the triggering event, the system may present a graphical user interface to an executor of the estate of the benefactor.

The graphical user interface illustrates the function of creating the account, transferring funds into the account, and establishing a manager over the account. The graphical user interface further displays a button that enables the executor to perform the function. Upon the executor selecting the button, the system may then automatically perform the functions. Thus, the executor decides that the function should be performed whiled the system actually performs the function. In other embodiments, the function may leave certain fields that need to be defined by the individual. This might include information that may not be available to the benefactor when defining the function. Following the above example, the function may allow the executor to define the manager of the account or an amount of funds to transfer. In some embodiments, the field may be selectable by the benefactor. For example, the benefactor may define a primary manager of the account and a secondary manager that would manage the account if the primary manager was unavailable. The graphical user interface would then present an option for the executor to select either the primary manager or the secondary manager based on information that is discovered by the executor after the triggering event. By allowing a benefactor to define these functions, an executor or another individual may efficiently perform the duties of the appointed position while maintaining control over the process. Thus, the benefactor may define with detail how to dispose of given assets.

In other embodiments of the invention, the benefactor may update the benefactor profile to provide incentives to one or more of the beneficiaries named in the benefactor profile. These incentives may be conditions of the designation established by the benefactor. For example, the benefactor could define an incentive of “Beneficiary A to receive Asset X if Beneficiary A has graduated college upon the occurrence of the triggering event.” A determination of whether Beneficiary A has graduated college is performed and if so, the designation is fulfilled. Alternatively, if the condition has not been performed, the designation is not fulfilled. In other embodiments, the incentive may be an enticement for the beneficiary to perform an action to receive an additional benefit to the designation. For example, the designation may state, “Beneficiary A to receive 10% of the assets in Account A, and if the Beneficiary should graduate college, an additional 5% of the assets in Account A.” In another embodiment, the beneficiary may be given the option to complete multiple incentives. For example, the designation may state concerning the distribution of assets of an account to a beneficiary, “1% for each year completed of education, 5% if married, 2% for each child, etc.” After the occurrence of the triggering event, incentives may be identified which include qualifications the beneficiary has met. Based on the incentives the beneficiary has completed, a calculation is performed to determine that amount the beneficiary may receive under the designation.

In some embodiments, the invention may be configured to communicate with an insurance provider or other third-party that manages a policy of the benefactor that becomes available upon the occurrence of the triggering event. Upon the triggering event, documents may be sent to the policy manager to redeem the policy. These documents may have been signed by the benefactor prior to the occurrence of the triggering event. In some embodiments, these documents are digitally signed and stored. In other embodiments, the documents may be physical. Upon the occurrence of the triggering event, the documents may be communicated to the policy manager. In some embodiments, a secure channel is created for communicating the documents. Further, the documents may be encrypted prior to communication.

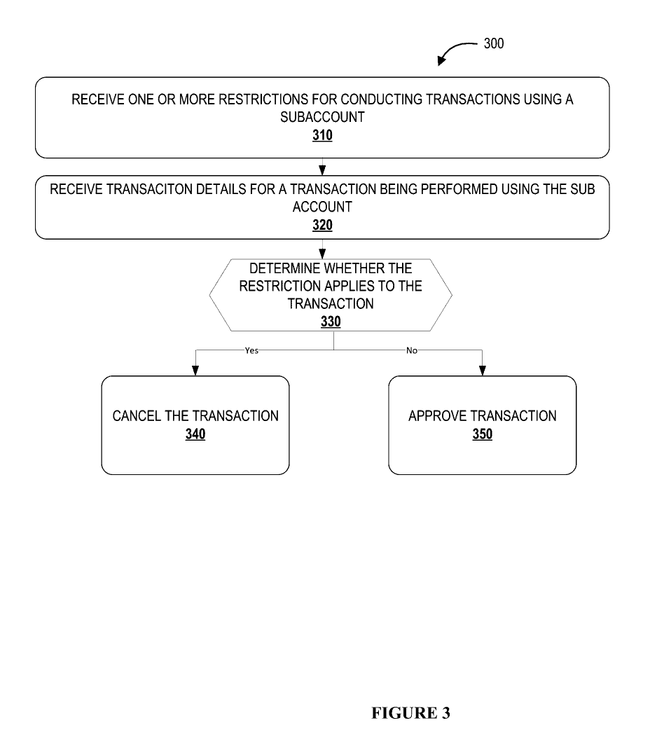

FIG. 3 illustrates a high level process flow 300 for performing transactions using a subaccount designated by a benefactor, in accordance with several embodiments of the present invention. Block 310 of FIG. 3 illustrates receiving one or more restrictions for conducting transactions using the subaccount. In some embodiments, the restrictions limit the performance of a transaction using the subaccount based on at least an amount of the transaction and a recipient of the transaction. The benefactor may update the benefactor profile described in FIG. 2 to include these restrictions. For example, the benefactor may specify that transactions using the subaccount may be limited to a given transaction account (e.g. $500). Additionally, the restriction may limit a recipient or a type of recipient of the transaction. This may include, for example, a particular merchant or a class of merchants (e.g. florists). While in other embodiments, the benefactor may specify a particular product or service of the transaction that may be allowed. For example, the benefactor may update the benefactor profile to include information of an executor of the estate of the benefactor. A subaccount is created naming the benefactor and the executor as managers of the account. Upon the death of the benefactor (i.e. the triggering event), $5000 will be transferred from a financial account of the benefactor into the subaccount. The benefactor may further update the benefactor profile with restrictions that all transactions of the subaccount must be used for funeral services of the benefactor. The benefactor may further update the benefactor profile to set a restriction that limits a transaction or floral arrangements to $500.

Block 320 illustrates receiving transaction details for a transaction being performed using the subaccount. The transaction details may include an amount of the transaction, a merchant of the transaction, and any other details that are commonly associated with a transaction. Following the above example, the executor may attempt to enter into a transaction to purchase flowers. The transaction may be for an amount of $800. After receiving these details, a determination may be made as to whether the restrictions apply to the transaction, as illustrated in block 330. Following the above example, a system may be used to identify that the transaction involves the purchase of flowers. The system may further compare the amount of the transaction against the amount set by the restriction. Using this information, the system may determine that the restriction applies to the transaction. In the event the restriction applies, the system may be configured to cancel the transaction, as illustrated in block 340. However, if the restriction did not apply, the system would approve the transaction, as illustrated in block 350.

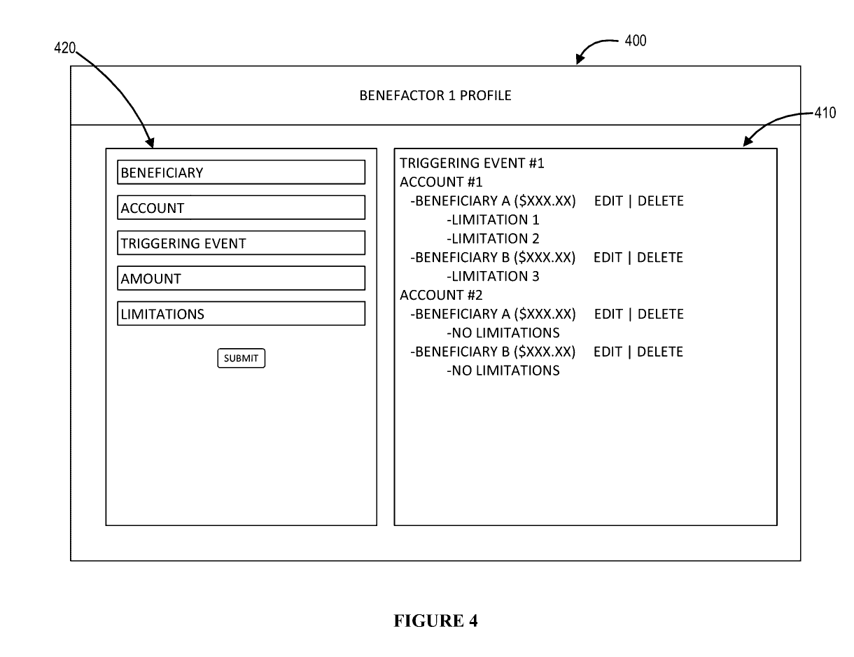

Now referring to FIG. 4. FIG. 4 presents an illustration of an interface 400 for creating and updating a benefactor profile, in accordance with several embodiments of the present invention. The interface 400 includes at least a presentation panel 410 and a submission panel 420. The presentation panel 410 may be configured to display beneficiary information included in a benefactor profile. The beneficiary information includes at least a description of a triggering event, account information from which assets will be dispersed upon an occurrence of the triggering event, information from one or more beneficiaries that will receive assets from the account upon the occurrence of the triggering event, and limitations for communicating the beneficiary information. The presentation panel 410 may be configured to present the beneficiary information in a hierarchal formal. For example, as illustrated in FIG. 4, a triggering event may be associated with multiple accounts from which assets will be dispersed upon an occurrence of the triggering event. The accounts may be associated with one or more beneficiaries that will receive the assets. Each of the beneficiaries may be associated with one or more restrictions for receiving communication relating to the beneficiary information. Additionally, the interface 400 may present options for a benefactor to edit the beneficiary information. Upon selecting the option to update the beneficiary information, the benefactor may be presented a panel that would allow the benefactor to make such an update. The interface 400 may also present an option for the benefactor to delete a portion of the beneficiary information. Upon the benefactor selecting an option to delete a portion of the benefactor information, the interface 400 would interact with a system, as defined herein, to update a corresponding benefactor profile. Thus changes made in the interface 400 would be communicated to the system for updating the benefactor profile stored within the system.

The interface 400 may be further configured to present the submission panel 420 that includes several text fields that would allow a benefactor to create a designation for a beneficiary to receive assets from an account managed by the benefactor upon the occurrence of a triggering event. The benefactor may select already existing information or input new information for the beneficiary. The interface 400 would also allow the benefactor to enter in an account from which assets would be distributed to the beneficiary upon the occurrence of the triggering event. The user may also be enabled to select the triggering event, an amount of the asset to distribute, and any limitations for communicating details of the designation to the beneficiary. After the submission panel 420 receives the information necessary to create the designation, the interface 420 may further include an option for the benefactor to submit the designation to the corresponding system, which would result in an update of the benefactor profile. The system may further communicate back a response that the benefactor profile was updated and an instruction for the interface 400 to update the beneficiary information included in the presentation panel 410 based on the designation information. In some embodiments, the interface 400 may include additional information about each of the accounts managed by the benefactor, which may include but is not limited to, an account balance, pending transactions on the account, a status of the account, any other managers of the account, and the like. The interface 400 may further include information about the status of the triggering event (e.g. a description of an occurrence of the triggering event).

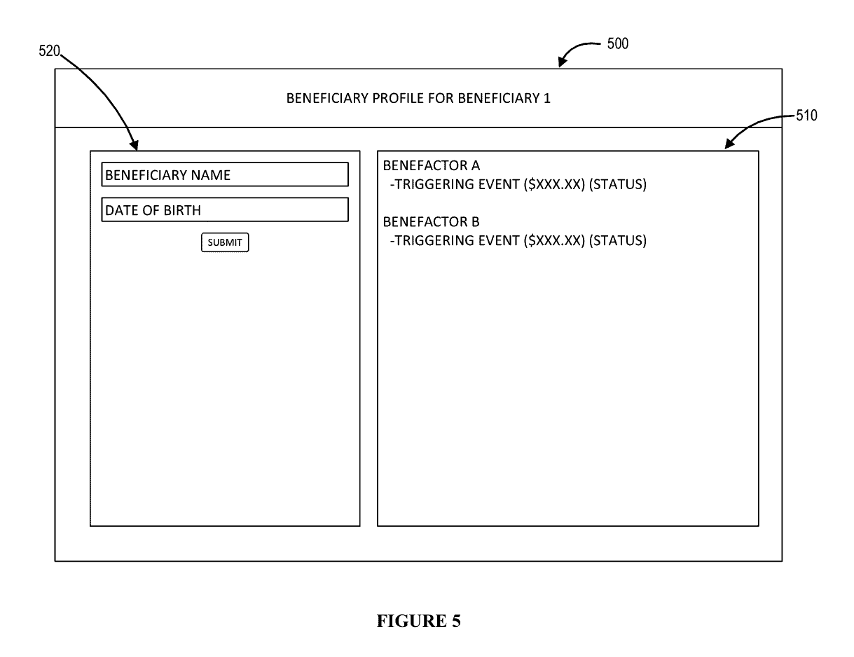

Now referring to FIG. 5. FIG. 5 presents an interface 500 for presenting information to a beneficiary relating to designations made by the benefactor for the beneficiary to receive assets from one or more accounts upon the occurrence of a triggering event, in accordance with several embodiments of the present invention. The interface 500 may be configured to display a presentation panel 510 and a submission panel 520. The presentation panel 510 may include information related to one or more designations each of which is made by one or more benefactors that name a beneficiary to receive funds from one or more accounts managed by each of the benefactors upon the occurrence of a triggering event. The designation information may include a name of a benefactor, a triggering event, an amount of assets that will be transferred to the beneficiary upon the occurrence of the triggering event, and a status of the triggering event. The designation information is received from a corresponding system that stores the designation information. The information is received based on a beneficiary submitting identifying information that is transmitted to the system. The system may limit the amount of information that may be displayed based on one or more limitations designated by the benefactor.

The interface 500 further includes a submission panel 520 that allows the beneficiary to supply the identification information. The identification information may include any information that could be used to identify the beneficiary. This information may include, but is not limited to, a name, a date of birth, a government issued identification, a street or mailing address, and the like. The submissions panel 520 may further include an option or the beneficiary to communicate such information to a system that is used to search for the designations made by the one or more benefactors that is communicated back to the interface 500 which is displayed in the presentation panel 510.

### INCORPORATION BY REFERENCE

To supplement the present disclosure, this application further incorporates entirely by reference the following commonly assigned patent applications:

| | U.S. patent application | | |
|---|---|---|---|
| Docket Number | Ser. No. | Title | Filed On |
| 6810US1.014033.2511 | 14/851,750 | SYSTEM FOR RESTRUCTURING | Sep. 11, 2015 |
| | | BASED ON PREDICTIVE ANALYSIS | |
| 6811US1.014033.2512 | 14/851,758 | UNIVERSAL TOKENIZATION | Sep. 11, 2015 |
| | | SYSTEM | |
| 6812US1.014033.2513 | 14/851,599 | SYSTEM FOR MODELING AND | Sep. 11, 2015 |
| | | IMPLEMENTING EVENT- | |
| | | RESPONSIVE RESOURCE | |
| | | ALLOCATION STRUCTURES | |
| 6813US1.014033.2514 | 14/851,623 | SYSTEM FOR SIMULATION AND | Sep. 11, 2015 |
| | | IMPLEMENTATION OF DYNAMIC | |
| | | STATE-DEPENDENT RESOURCE | |
| | | RECONFIGURATION | |
| 6815US1.014033.2515 | 14/851,848 | SYSTEM FOR DYNAMIC | Sep. 11, 2015 |
| | | VISUALIZATION OF | |
| | | INDIVIDUALIZED CONSUMPTION | |
| | | ACROSS SHARED RESOURCE | |
| | | ALLOCATION STRUCTURE | |
| 6817US1.014033.2516 | 14/851,765 | SYSTEM FOR ANALYZING PRE- | Sep. 11, 2015 |
| | | EVENT AND POST-EVENT | |
| | | INDIVIDUAL ACCOUNTS AND | |
| | | TRANSFORMING THE ACCOUNTS | |
| 6818US1.014033.2517 | 14/851,769 | SYSTEM FOR OPENING AND | Sep. 11, 2015 |
| | | CONSOLIDATING ACCOUNTS | |
| | | BASED ON AN EVENT | |
| | | ASSOCIATED WITH THE ACCOUNT | |
| | | HOLDER | |
| 6824US1.014033.2518 | TBD | SYSTEM FOR DETERMINATION | Concurrently |
| | | AND TRACKING OF ASSET | Herewith |
| | | LINEAGE | |
| 6825US1.014033.2519 | TBD | SYSTEM FOR DETERMINATION | Concurrently |
| | | AND TRANSFER OF ASSETS | Herewith |
| 6826US1.014033.2520 | TBD | SYSTEM FOR RESTRUCTURING | Concurrently |
| | | BASED ON INTENT ANALYSIS | Herewith |
| 6827US1.014033.2521 | TBD | SYSTEM FOR ASSESSMENT OF | Concurrently |
| | | ALLOCATED ASSETS | Herewith |
| 6828US1.014033.2522 | TBD | SYSTEM FOR DYNAMIC | Concurrently |
| | | GENERATION OF ALLOCATION | Herewith |
| | | GUIDE FOR ASSETS | |

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for distributing assets upon the occurrence of a triggering event, wherein the system comprises:
a memory;
a communication interface;
one or more processors; and
executable code stored in memory, wherein the code, when executed by the one or more processors, causes the one or more processors to:
identify a main account of a benefactor, wherein the main account contains assets of the benefactor that the benefactor desires to distribute to one or more individuals upon the occurrence of a triggering event;
receive, from the benefactor, information that identifies each of the one or more individuals;
create, for each of the one or more individuals, a subaccount that is associated with the main account, wherein the subaccount names the benefactor and at least one of the one or individuals as managers of the account, wherein the subaccount does not include any portion of the assets of the main account prior to the occurrence of the triggering event;
receive, from the benefactor, designations for transferring a portion of the assets from the main account into the subaccount based on the occurrence of the triggering event;
identify the occurrence of the triggering event; and
transfer the portion of the assets from the main account into the subaccount based on identifying the occurrence of the triggering event.

2. The system of claim 1, wherein the executable code further comprises instruction code configured to cause the one or more processors to:
receive one or more restrictions for conducting transactions using the subaccount, wherein the one or more restrictions restrict completion of the transaction based on at least one of an amount of the transaction, and a recipient of the transaction;
receive a notification that the individual named on the subaccount is attempting to perform the transaction using the subaccount, wherein the notification comprises at least the amount of the transaction and the recipient of the transaction;
determine whether the one or more restrictions apply to the transaction based on the amount of the transaction and the recipient of the transaction; and
complete the transaction if the one or more restrictions do not apply to the transaction.

3. The system of claim 1, wherein the triggering event is a death of the benefactor, and wherein the executable code further comprises instruction code configured to cause the one or more processors to create a subaccount for receiving assets from the main account to pay for funeral related expenses of the benefactor.

4. The system of claim 1, wherein the executable code further comprises instruction code configured to cause the one or more processors to communicate a notification of the occurrence of the triggering event to the at least one individual named to manage the subaccount, wherein communicating the notification occurs after the occurrence of the triggering event.

5. The system of claim 1, wherein the executable code further comprises instruction code configured to cause the one or more processors to:
identify a purpose for the subaccount;
determine, after the occurrence of the triggering event, that the purpose of the subaccount is no longer valid;
identify residual funds included in the subaccount, wherein the residual funds include any assets left in the subaccount after determining the purpose of the subaccount is no longer valid; and
apply a second set of restrictions for restricting transactions on the subaccount based on identifying the purpose is no longer valid, wherein the second set of restrictions are less restrictive than the one or more restrictions, wherein transactions may be performed using the residual funds included in the subaccount that could not be performed prior to determining that the purpose of the subaccount was no longer valid.

6. The system of claim 5, wherein determining that the purpose of the subaccount is no longer valid is based on the occurrence of a second triggering event, wherein the second triggering event occurs after the occurrence of the triggering event, and wherein the second triggering event causes the purpose of the subaccount to no longer be valid.

7. The system of claim 6, wherein the second triggering event may be a life event of an individual other than the benefactor.

8. A computer program product for distributing assets upon the occurrence of a triggering event, the computer program product comprising:
identify a main account of a benefactor, wherein the main account contains assets of the benefactor that the benefactor desires to distribute to one or more individuals upon the occurrence of a triggering event;
receive, from the benefactor, information that identifies each of the one or more individuals;
create, for each of the one or more individuals, a subaccount that is associated with the main account, wherein the subaccount names the benefactor and at least one of the one or individuals as managers of the account, wherein the subaccount does not include any portion of the assets of the main account prior to the occurrence of the triggering event;
receive, from the benefactor, designations for transferring a portion of the assets from the main account into the subaccount based on the occurrence of the triggering event;
identify the occurrence of the triggering event; and
transfer the portion of the assets from the main account into the subaccount based on identifying the occurrence of the triggering event.

9. The computer program product of claim 8, wherein updating the benefactor profile comprises:
receive one or more restrictions for conducting transactions using the subaccount, wherein the one or more restrictions limit completion of the transaction based on at least one of an amount of the transaction, and a recipient of the transaction;
receive a notification that the individual named on the subaccount is attempting to perform the transaction using the subaccount, wherein the notification comprises at least the amount of the transaction and the recipient of the transaction;
determine whether the one or more restrictions apply to the transaction based on the amount of the transaction and the recipient of the transaction; and
complete the transaction if the one or more restrictions do not apply to the transaction.

10. The computer program product of claim 8, wherein the triggering event is a death of the benefactor, and wherein the computer readable program code being further configured to cause the one or more processors to create a subaccount for receiving assets from the main account to pay for funeral related expenses of the benefactor.

11. The computer program product of claim 8, wherein the computer readable program code being further configured to cause the one or more processors to communicate a notification of the occurrence of the triggering event to the at least one individual named to manage the subaccount, wherein communicating the notification occurs after the occurrence of the triggering event.

12. The computer program product of claim 8, wherein the computer readable program code being further configured to cause the one or more processors to:
identify a purpose for the subaccount;
determine, after the occurrence of the triggering event, that the purpose of the subaccount is no longer valid;
identify residual funds included in the subaccount, wherein the residual funds include any assets left in the subaccount after determining the purpose of the subaccount is no longer valid; and
apply a second set of restrictions for restricting transactions on the subaccount based on identifying the purpose is no longer valid, wherein the second set of restrictions are less restrictive than the one or more restrictions, wherein transactions may be performed using the residual funds included in the subaccount that could not be performed prior to determining that the purpose of the subaccount was no longer valid.

13. The computer program product of claim 12, wherein determining that the purpose of the subaccount is no longer valid is based on the occurrence of a second triggering event, wherein the second triggering event occurs after the occurrence of the triggering event, and wherein the second triggering event causes the purpose of the subaccount to no longer be valid.

14. A computer implemented method for distributing assets upon the occurrence of a triggering event, the method comprising:
identifying a main account of a benefactor, wherein the main account contains assets of the benefactor that the benefactor desires to distribute to one or more individuals upon the occurrence of a triggering event;
receiving, from the benefactor, information that identifies each of the one or more individuals;
creating, for each of the one or more individuals, a subaccount that is associated with the main account, wherein the subaccount names the benefactor and at least one of the one or individuals as managers of the account, wherein the subaccount does not include any portion of the assets of the main account prior to the occurrence of the triggering event;
receiving, from the benefactor, designations for transferring a portion of the assets from the main account into the subaccount based on the occurrence of the triggering event;
identifying the occurrence of the triggering event; and
transferring the portion of the assets from the main account into the subaccount based on identifying the occurrence of the triggering event.

15. The computer implemented method of claim 14, wherein updating the benefactor profile comprises:
receiving one or more restrictions for conducting transactions using the subaccount, wherein the one or more restrictions limit completion of the transaction based on at least one of an amount of the transaction, and a recipient of the transaction;
receiving a notification that the individual named on the subaccount is attempting to perform the transaction using the subaccount, wherein the notification comprises at least the amount of the transaction and the recipient of the transaction;
determining whether the one or more restrictions apply to the transaction based on the amount of the transaction and the recipient of the transaction; and
completing the transaction if the one or more restrictions do not apply to the transaction.

16. The computer implemented method of claim 14, wherein the triggering event is a death of the benefactor, and wherein the method further comprises creating a subaccount for receiving assets from the main account to pay for funeral related expenses of the benefactor.

17. The computer implemented method of claim 14, wherein the method further comprises communicating a notification of the occurrence of the triggering event to the at least one individual named to manage the subaccount, wherein communicating the notification occurs after the occurrence of the triggering event.

18. The computer implemented method of claim 14, wherein the method further comprises:
identifying a purpose for the subaccount;
determining, after the occurrence of the triggering event, that the purpose of the subaccount is no longer valid;
identifying residual funds included in the subaccount, wherein the residual funds include any assets left in the subaccount after determining the purpose of the subaccount is no longer valid; and
applying a second set of restrictions for restricting transactions on the subaccount based on identifying the purpose is no longer valid, wherein the second set of restrictions are less restrictive than the one or more restrictions, wherein transactions may be performed using the residual funds included in the subaccount that could not be performed prior to determining that the purpose of the subaccount was no longer valid.

19. The computer implemented method of claim 18, wherein determining that the purpose of the subaccount is no longer valid is based on the occurrence of a second triggering event, wherein the second triggering event occurs after the occurrence of the triggering event, and wherein the second triggering event causes the purpose of the subaccount to no longer be valid.

20. The computer implemented method of claim 19, wherein the second triggering event may be a life event of an individual other than the benefactor.
